(19) United States
(12) Patent Application Publication
(10) Pub. No.: US 2011/0001706 A1
(43) Pub. Date: Jan. 6, 2011

(54) ELECTRONIC DEVICE TOUCH SCREEN DISPLAY MODULE

(76) Inventors: Emery Sanford, San Francisco, CA (US); Stephen P. Zadesky, Portola Valley, CA (US)

Correspondence Address: Treyz Law Group, 870 Market Street, Suite 984, SAN FRANCISCO, CA, 94102, US

(21) Appl. No.: 12/497,358

(22) Filed: Jul. 2, 2009

(51) Int. Cl. G06F 3/041

(52) U.S. Cl. 345/173

(57) ABSTRACT

An electronic device may have a housing in which a touch screen display module is mounted. A cover glass may cover the touch screen display module. The touch screen display module may include display structures and touch sensor structures. A first cable may be connected to the display structures along an edge of the touch screen display module. A second cable may be connected to the touch sensor structures along another edge of the touch screen display module. The cables may be formed from flex circuits that are connected to the display module using heat-and-pressure-bondable conductive adhesive. A printed circuit board in electronic device may have connectors that receive the ends of the first and second flex circuits. The connectors may be located along a common edge of the printed circuit board to facilitate assembly of the touch screen display module within the housing of the electronic device.

### BACKGROUND

This invention relates generally to electronic devices, and more particularly, to touch screen display modules for electronic devices.

Electronic devices are often provided with touch screen displays. For example, some cellular telephones and computers have touch screens. Touch screens can be used to recognize user touch input. For example, touch screens may be used to implement on-screen buttons and may be used to gather multitouch commands from a user. Electronic devices with touch screens may offer more functionality than devices without touch screens and, because the presence of touch input functionality allows an electronic device to be operated with fewer buttons, touch screens make it possible to reduce device size.

Touch screens contain display structures and touch sensors. The display structures for a touch screen may, for example, be based on liquid crystal display (LCD) technology. In a typical LCD arrangement, an array of LCD pixels is formed on a glass substrate. A backlight may be used to produce light for the display structures. Light from the backlight passes through the glass substrate and the LCD pixel array. A desired image may be produced by controlling the LCD pixels in the LCD array.

The touch screen for the display may be formed using acoustic or resistive touch sensor technology. Many touch screens use arrays of capacitive touch sensor electrodes. In a capacitive touch sensor array, the presence of a user's finger or other external object may be detected by measuring capacitance changes on the touch screen electrodes. By identifying the electrode or electrodes that are exhibiting changes in capacitance, the location of the user's touch can be determined.

In compact devices such as the devices in which it is desired to use touch screens, space is often at a premium. In these situations, it can be difficult to form a touch screen module that can be mounted satisfactorily within a device housing. For example, it can be difficult to make electrical attachment to a touch screen display without creating protruding structures of the type that can be difficult to fit within a compact device.

It would therefore be desirable to be able to provide improved touch screen displays for electronic devices.

### SUMMARY

An electronic device such as a cellular telephone or a media player may have a touch screen display module. The touch screen display module may be formed using a layer of substrate glass. An array of display pixels may be formed on the substrate glass. The array of display pixels may be formed from light-emitting diodes such as organic light-emitting diodes.

A layer of encapsulation glass may be used to encapsulate the light-emitting diodes. A touch sensor may be formed on the layer of encapsulation glass. The touch sensor may include an array of transparent conductive electrodes. The touch sensor electrodes may, for example, be formed from indium-tin oxide pads.

The electronic device may have a housing. The touch screen display module may be mounted in the housing. A layer of cover glass may be used to cover the touch screen display module. A printed circuit board may be mounted in the housing. Circuitry on the printed circuit board may be used in processing touch sensor signals from the touch sensor and in producing image data for the light-emitting diode array.

A first flex circuit may be connected to the touch sensor to convey touch sensor signals to the printed circuit board. A second flex circuit may be connected to the light-emitting diode array to convey display data to the display portion of the display module.

The touch screen display module may be rectangular (e.g., square) and may have four edges. The first and second flex circuits may be connected along different edges of the touch screen display module. The edges at which the first and second flex circuits are attached may, for example, be opposing edges.

The flex circuits may be connected to a common edge of the printed circuit board to facilitate tilting of the display module relative to the printed circuit board during assembly of the electronic device.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device in accordance with an embodiment of the present invention.

FIG. 2 is a cross-sectional side view of a conventional touch screen display module.

FIG. 3 is a cross-sectional side view of an illustrative touch screen display module in accordance with an embodiment of the present invention.

FIG. 4 cross-sectional side view of a conventional touch sensor display module in which touch sensor and display flex circuit cables are attached to the same edge of the module.

FIG. 5 is a cross-sectional side view of an illustrative electronic device having a touch screen display module in accordance with an embodiment of the present invention.

### DETAILED DESCRIPTION

Touch screens are desirable in many modern electronic devices. Touch screen functionality allows a user to supply input by touching a portion of a display. With non-touch arrangements, a pointing device such as a mouse or trackpad may be needed to allow a user to interact with displayed information. Touch screens allow the same type of user interaction, but avoid the need for additional input devices. Touch screens also enable users to supply input in ways that are not possible using non-touch equipment. For example, touch screens can be used to gather input from multiple touch locations. So-called multitouch capabilities allow devices to be provided with enhanced touch functionality. Multitouch gestures may, for example, be used to control a computer or cellular telephone in ways that would be cumbersome or impossible using other types of user input interfaces.

Touch screen displays may, in general, be implemented using any suitable touch sensor technology (e.g., touch sensors based on light, touch sensors based on resistance changes, touch sensors based on acoustic sensing arrangements, etc.). With one suitable arrangement, which is sometimes described herein as an example, a touch screen display module may be implemented using an array of capacitive touch sensors. Capacitive touch sensors use an array of capacitor electrodes. The electrodes may, for example, be arranged in a pattern of rows and columns. When an object such as a user's finger comes within a given distance of an electrode, a resulting capacitance change on the electrode can be detected. By monitoring the capacitances of all of the electrodes in the array, the position of a user's fingers within the array can be monitored.

Touch screen display modules may be used in any suitable electronic devices. For example, touch screen display modules may be used in desktop computer monitors or in televisions. Touch screen display modules may also be used in laptop computers, tablet computers, and other portable electronic devices. Touch screen display modules may be helpful in reducing device size without overly constricting device functionality, particularly when used in relatively compact portable electronic devices such as handheld electronic devices, wrist-mounted devices, and pendant devices. The use of touch screen displays in compact portable electronic devices such as handheld electronic devices is therefore sometimes described as an example. This is, however, merely illustrative. Touch screen display modules may be used in any suitable electronic device if desired.

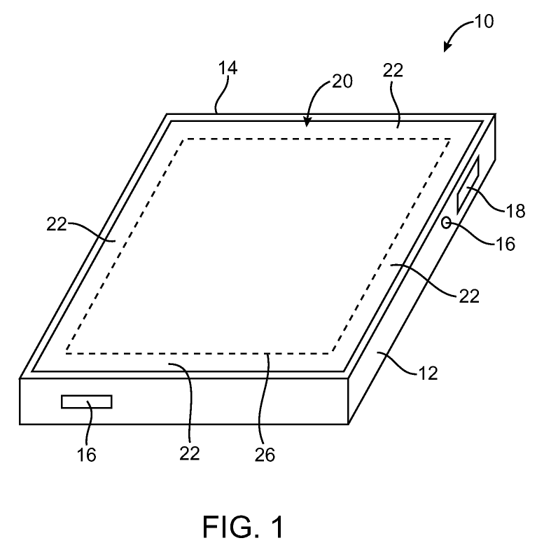

An illustrative electronic device that may be provided with a touch screen display module in accordance with an embodiment of the present invention is shown in FIG. 1. Device 10 of FIG. 1 may be, for example, an electronic device such as a media player or cellular telephone. Device 10 may, if desired, be an electronic device that supports wireless functions. Device 10 may have storage and processing circuitry that allows device 10 to run code. The code may be used in implementing functions such as internet browsing functions, email and calendar functions, games, music player functionality, digital image acquisition functions, flash and shutter control operations, indicator light functions, etc.

Device 10 may have a housing such as housing 12. Housing 12 may be formed of any suitable materials including plastic, glass, ceramics, metal, other suitable materials, or a combination of these materials. Bezel 14 may serve to hold a display such as display 20 in place on device 10 or to serve as a cosmetic trim.

Display 20 may be a liquid crystal display (LCD), an organic light emitting diode (OLED) display, or any other suitable display. The outermost surface of display 20 may be formed from one or more plastic or glass layers. A capacitive touch sensor array may be integrated into display 20 to make display 20 touch sensitive.

Touch screen display 20 is merely one example of an input-output device that may be used with electronic device 10. If desired, electronic device 10 may have other input-output devices. For example, electronic device 10 may have user input control devices such as button 18 and input-output components such as ports 16. Button 18 may be, for example, a slidable switch or a button that can be pressed. Ports 16 may include audio jacks, universal serial bus ports, and other digital and analog input-output connectors. Openings in housing 12 may, if desired, form speaker and microphone ports. In the example of FIG. 1, display screen 20 is shown as being mounted on the front face of electronic device 10, but display screen 20 may, if desired, be mounted on the rear face of electronic device 10, on a side of device 10, on a flip-up portion of device 10 that is attached to a main body portion of device 10 by a hinge (for example), or using any other suitable mounting arrangement.

A user of electronic device 10 may supply input commands using user input interface devices such as button 18 and touch screen 20. Suitable user input interface devices for electronic device 10 include buttons (e.g., alphanumeric keys, power on-off, power-on, power-off, and other specialized buttons, etc.), a touch pad, pointing stick, or other cursor control device, a microphone for supplying voice commands, or any other suitable interface for controlling device 10. Although shown as being formed on a side wall of electronic device 10 in the example of FIG. 1, buttons such as button 18 and other user input interface devices may generally be formed on any suitable portion of electronic device 10. For example, a button such as button 18 or other user interface control may be formed on the front surface of electronic device 10 (i.e., as part of the same planar surface that includes display 20). Buttons and other user interface controls can also be located on the rear face, end faces, or other portions of device 10.

Device 10 may have a square outline (i.e., a rectangle with edges of equal length of the type shown in FIG. 1), an elongated rectangular outline, an oval or circular outline, an outline with curved and strait edges, or any other suitable shape. The use of the square housing shape of FIG. 1 is sometimes described herein as an example.

Display 20 may be covered with a transparent plastic or glass cover. This cover, which is sometimes referred to as the display “cover glass” may extend over the exposed surface of device 10, as shown in FIG. 1. Central region 26 of display 20 may be provided with touch-screen functionality. Touch screen functionality may be provided using resistive touch sensors, acoustic-based touch sensors, capacitive touch sensors, or any other suitable touch sensor arrangement. For example, transparent touch screen electrodes for a capacitive touch sensor array may be provided on structures that are mounted underneath the cover glass in central region 26. Transparent touch screen electrodes may be formed out of a transparent conductive material such as indium tin oxide (ITO). The use of ITO electrodes in forming capacitive touch sensor arrays for display 20 is sometimes described herein as an example, but other electrode materials may be used if desired.

Because region 26 is sensitive to touch input (e.g., when a user's finger or other external objects are detected within a particular proximity of the touch sensor), region 26 is sometimes referred to as the active region. Portions of display 20 outside of active region 26 (e.g., peripheral regions 22 in the example of FIG. 1) do not contain touch sensor electrodes and may therefore sometimes be referred to as inactive regions. The undersides of the cover glass of display 20 in inactive regions 22 may be coated with an opaque ink (e.g., black ink) to hide components under regions 22 from view. These inactive regions may also be covered with portions of bezel 14.

To ensure that device 10 is not overly bulky and to improve device aesthetics, it may be desirable to minimize the width of inactive regions 22. Displays that have large inactive areas may be difficult to mount within a compact device and may appear unattractive. Displays with small inactive areas may be suitable for inclusion in miniature devices and may have improved aesthetics. Displays that are thin may also be used in implementing attractive small form factor devices.

The thickness of touch screen displays can be adversely affected when many glass layers are included within the display. Display thickness can be minimized by reducing the number of glass layers.

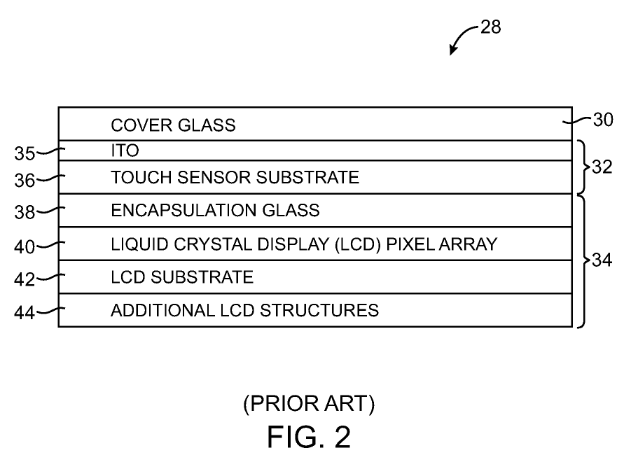

A cross-section of a conventional touch screen display is shown in FIG. 2. As shown in FIG. 2, touch screen display module 28 includes a touch sensor 32 and a display 34.

Display 34 may be a liquid crystal diode (LCD) display formed from an array of LCD pixels (LCD pixel array 40). The structures of pixel array 40 may be formed on glass substrate 42 and may be covered with encapsulation glass 38. Structure 44 may include backlight structures, polarizers, diffusers, and other conventional LCD structures. In a typical scenario, display 34 may be provided by a display manufacturer as a unit.

Touch sensor array 32 may also be provided as a unit. Touch sensor 32 may include glass panel 36 and touch sensor electrodes 35. Glass panel 36 may serve as a touch sensor substrate. Touch sensor electrodes 35 may be formed from an array of indium tin oxide (ITO) structures on substrate layer 36.

During assembly of touch screen display module 28 of FIG. 2, touch sensor 32 may be attached to LCD display 34 using adhesive. Cover glass 30 may be placed on top of touch sensor 32 to protect electrode array 34 from damage.

When assembled as shown in FIG. 2, devices with conventional touch sensor displays include at least four glass layers (substrate 42, encapsulation glass layer 38, touch sensor substrate 36, and cover glass 30), which can be fairly thick and bulky.

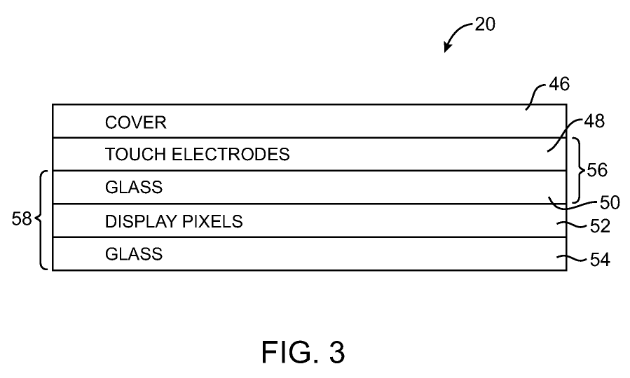

A touch screen display module of the type that may be used in device 10 of FIG. 1 is shown in FIG. 3. As shown in FIG. 3, display 20 may have a first layer such as glass layer 54 and a second layer such as glass layer 50 and may be covered by a third layer such as cover layer 46. There are only three glass layers in the arrangement of FIG. 3, so display size may be minimized.

The glass layers in display module 20 can be transparent for passing light from pixels 52. Glass can also be formed with a smooth finish and can be raised to potentially large temperatures during processing. Because glass is a dielectric, signals may pass along traces on the surface of a glass layer without interference. For reasons such as these, it is generally desirable to use glass (e.g., transparent glass) to form the layers of display module 20. In general, however, any suitable dielectric can be used (e.g., ceramic, plastic, composites, etc.) The use of glass in forming the dielectric layers of display module 20 is merely illustrative.

Layer 54 may be formed from glass or other suitable dielectric materials and may serve as a substrate for an array of display pixels. Display pixel array 52 may be formed on layer 54. Display pixel array 52 may be formed using any suitable display technology (e.g., liquid crystal diode technology, light-emitting diode technology, etc.) With one suitable arrangement, which is sometimes described herein as an example, display pixels 52 are formed from individually controllable light-emitting diode structures such as organic light-emitting diode (OLED) structures (i.e., display pixels 52 form an OLED array).

Layer 50 may be a transparent layer of glass or other suitable material and may be formed over display pixels 52 to encapsulate pixels 52.

Touch sensor electrodes 48 may be formed on glass layer 50. Touch sensor electrodes 48 may be formed from a transparent conductive material such as indium-tin oxide. An array of electrodes such as electrodes 48 may be formed in rows and columns on the surface of glass 50.

Cover layer 46 may be formed from a transparent layer of glass, plastic, or other suitable materials.

With the arrangement shown in FIG. 3, first glass layer 54, display pixel array 52, and layer 50 form display 58 for module 20, whereas glass 50 and touch sensor electrode array 48 form touch sensor 56. Layer 50 therefore serves both as an encapsulant glass layer for display 58 and as a substrate layer for touch sensor 56. Because layer 50 serves dual purposes, it is possible to form module 20 with fewer layers than conventional displays of the type shown in FIG. 2.

When forming a display using an arrangement of the type shown in FIG. 3, it may be desirable to minimize the amount of space taken up along the edges of the display when forming electrical attachments to the display. A touch screen display has an array of pixels to which data for displaying an image must be provided. A touch screen display also has an array of touch sensor electrodes from which touch sensor data must be gathered. Functions such as these require appropriate interconnect pathways. For example, a display data path is needed to route display data to display 58 and a touch sensor data path is needed to obtain touch sensor data from touch sensor 56.

The display data path and touch sensor path may be formed using individual wires, bundles of wires, cables, printed circuit boards, traces on rigid substrates formed from plastic or ceramic, etc. With one suitable arrangement, which is described herein as an example, the display data path and touch sensor path are implemented using flexible printed circuit board structures (“flex circuits”). Flex circuits are formed from flexible sheets of substrate. The flexible substrate sheets may be, for example, flexible sheets of polymer such as polyimide. A pattern of conductive traces may be formed on the flexible substrates. The conductive traces may be formed from a metal or metal alloy such as silver, gold, or copper (as examples).

Flex circuits may include numerous closely-spaced parallel traces. Flex circuits may also be extremely thin (e.g., less than 100 microns). Due to their small thickness and their ability to flex, flex circuits are advantageous in situations in which it is desired to save space (e.g., in the interior of a portable electronic device).

Flex circuits used as data pathways (buses) may have conductive pads that mate with corresponding conductive pads on device components. For example, one end of the flex circuit that is used in implementing the display data path may be connected to the display using conductive pads and the other end of the flex circuit that is used in implementing the display data path may be connected to a printed circuit board that contains display electronics using conductive pads. Flex circuits may be connected to desired circuitry using a connector such as a zero-insertion-force (ZIF) connector or other suitable connector that has been mounted to a printed circuit board (as an example). Flex circuits may also be attached to electrical components using conductive adhesive (sometimes referred to as “anisotropic conductive film” or ACF). Flex circuits that have conductive pads that have been coated with heat-and-pressure-bondable conductive adhesive may be electrically and physically connected to the mating conductive pads on a device component by the application of heat and pressure.

The use of conductive adhesive to bond a flex circuit path to the display and touch sensor circuitry of touch screen display 20 of FIG. 3 may help reduce the size of display 20 (e.g., by avoiding the use of potentially bulky electrical connectors in forming electrical connections to display 20). The thinness of flex circuit paths makes them suitable for situations in which vertical space is valuable. Although heat-and-pressure-bondable conductive adhesives are desirable for saving space, other types of arrangements may be used in forming electrical and physical connections between the flex circuits or other data paths and touch screen display components. For example, conductive epoxy that is cured by application of ultraviolet-light or by application of heat may be used, solder joints may be used, welds may be used, springs may be used, connectors such as ZIF connectors may be used, etc. The use of heat-and-pressure-bondable conductive adhesive is merely illustrative.

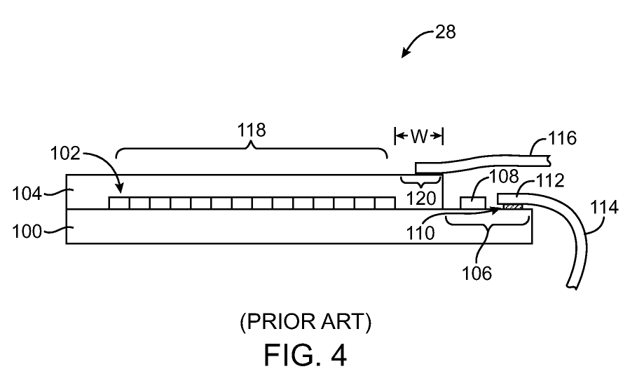

When using heat-and-pressure-bondable conductive adhesive to attach flex circuit cables to display 20, care should be taken to include sufficient lateral space in the vicinity of the flex attachment region. A cross-sectional view of a conventional display that shows how a flex circuit cable may be attached to a portion of the display is shown in FIG. 4. As shown in FIG. 4, display 28 may have a substrate layer such as substrate glass layer 100. Organic light-emitting diodes 102 may be formed on layer 100. Glass layer 104 may serve as a display encapsulation layer and as a substrate for a touch sensor array. The touch sensor array may be formed from a pattern of indium-tin oxide (ITO) traces or other transparent conductive traces on the surface of layer 104. A vertical offset may be formed on the underside of layer 104 above light-emitting diodes 102 to avoid damage to light-emitting diodes 102.

As shown in FIG. 4, the right-hand edge of glass 104 may be recessed from the edge of glass 100. This creates ledge 106. Display driver circuit 108 may be mounted on this ledge. Conductive traces such as conductive traces 110 are used in forming contact pads and interconnects that connect driver circuit 108 with display pixel array 102. Conductive traces 110 may be connected to conductive pads on tip 112 of flex circuit cable 114 using heat-and-pressure-bondable conductive adhesive.

With an arrangement of the type shown in FIG. 4, flex circuit 114 may be used to form a data path for display pixel array 102. Image data may be conveyed to circuit 108 using flex circuit path 102. Circuit 108 may drive this data into the pixels of array 102 to display an image for a user.

To form a data path for the touch sensor array on the upper surface of glass layer 104, a separate flex cable may be attached to display 28 (i.e., flex circuit 116). Because pixels 102 are only located in active region 118, it may be desirable to cover only active region 118 with touch sensor electrodes. In this type of configuration, inactive region 120 of glass 104 is substantially free of capacitive electrodes for the touch sensor array. This allows the ITO or other conductive trace material that is being used to form the capacitive touch sensors to be used to form contact pads for a touch sensor data path flex circuit. Touch sensor flex circuit 116 may be attached to these contact pads using a heat-and-pressure-bondable conductive adhesive (as an example).

As shown in FIG. 4, there is a width W associated with inactive region 120. Width W must be sufficiently large to ensure a satisfactory contact between the touch sensor data path flex circuit and the touch sensor contact pads. If width W is too small, there will not enough free surface area on glass layer 50 to connect the touch sensor flex circuit. If width W is sufficiently large, however, there will be an adequate setback from the edge of active region 118 to prevent the flex circuit from being visible to the user (i.e., sufficient clearance to hide the flex circuit under a bezel and to satisfy required tolerances for forming the heat-and-pressure-bondable contacts between the flex circuit traces and the mating contact pads on the surface of glass 104.

With the conventional arrangement of FIG. 4, a touch sensor data path flex circuit 116 is bonded to the inactive region of glass 104 at the same edge of display 28 as ledge 106 as shown in FIG. 4. While this type of arrangement may be satisfactory in some circumstances, it tends to increase the required width W. For example, W may need to be about 2.9 mm for a typical bonding process. This 2.9 mm width contributes to the size of the unused portion of the display. If, for example, ledge 106 is 2.3 mm in width, the total size of the inactive edge portion of the display would be 2.9 mm (for the touch flex bond region) +2.3 mm (for display driver circuit 108 and the display flex bond in region 106). The total inactive region with in this example would be 5.2 mm (i.e., 2.9 mm+2.3 mm). This may be undesirably large and may lend an unsightly overly-large appearance to the particular edge of the display to which both flex circuits are attached.

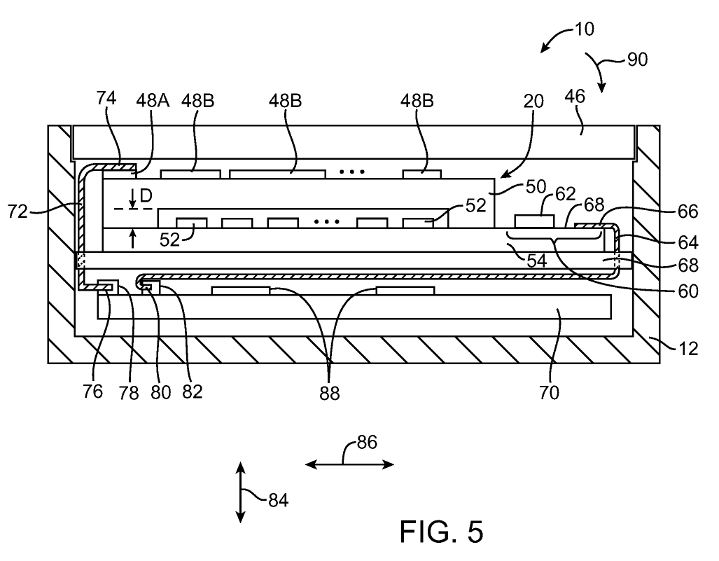

To create a more balanced set of inactive region widths around the four edges of the display, the bonding location for the touch sensor flex circuit may be located on a different edge of the display than the bonding location for the display flex circuit as shown in FIG. 5. This allows the width of the bonding region on the edge that contains substrate ledge 60 to be reduced (e.g., to about 1.7 mm). The edge of the encapsulant glass to which the touch sensor flex is attached (i.e., the left-hand edge of display module 20 in FIG. 5) will still need sufficient area to form a satisfactory flex circuit attachment, but because this region is not on the same edge as ledge 60, there is no single edge of the display module that is overly enlarged. The overall appearance of device 10 may therefore be improved.

As shown in FIG. 5, electronic device 10 may have a housing 12 to which a transparent cover layer such as cover glass 46 may be mounted. A gasket and bezel may be used in mounting cover glass 46 in housing 12 if desired.

Display 20 may include touch sensor structures and display structures. The display portion of display module 20 may include substrate 54, pixels 52, and glass layer 50. Glass layer 50 may also be used as part of the touch sensor structures by forming a substrate for touch sensor electrodes 48B.

Substrate 54 may be formed of glass or other suitable substrate materials and may be supported by support structures such as metal plate 68. Plate 68 may be mounted to the housing side walls of housing 12 (as an example). Other types of support structures may also be used (e.g., frame structures, support posts, structures formed from plastic, glass, or other dielectrics, etc.). The support structures may support display substrate layer 54 and other components in device 10 (e.g., main logic board 70).

Display pixels 52 may be formed on substrate layer 54. Display pixels 52 may be organic light-emitting diode pixels in an OLED array or may be any other suitable individually controllable display structures for forming pixels in an image (e.g., LCD pixels). Glass layer 50 may be mounted above layer 54 to encapsulate and cover light-emitting diodes 52. As shown in FIG. 5, the lower surface of layer 50 may be offset from the opposing upper surface of layer 54 (e.g., by an offset distance D of about 40 microns) to avoid damaging light-emitting diodes 52. The offset D may be created using a lip around the edge of the lower portions of layer 50 or a lip around the edge of the upper portions of layer 54. Offset D may also be formed by interposing shim structures between the edges of layer 50 and layer 54.

One or more integrated circuits may be used to implement display driver circuitry 62. Circuitry 62 may be mounted on ledge 60 of layer 54. Conductive traces 68 on the surface of layer 54 may be used to interconnect light-emitting diodes 52 to circuitry 62 and to pads on the underside of end 66 of flex circuit 64 using heat-and-pressure-bondable conductive adhesive. Flex circuit 64 may be used to form a display data path for device 10. End 80 of flex circuit 64 may be connected to circuitry 88 on printed circuit board 70 using zero-insertion-force (ZIF) connector 80 or other suitable flex circuit connection arrangement. Circuitry 88 may be used to provide display driver circuitry 62 with image data. Display driver circuitry 62 may convert the image data into signals for turning on and off pixels in pixel array 52. Using circuitry 88 and driver circuitry 62, a desired image may be produced on the display. If desired, circuitry 62 and circuitry 88 may be mounted on a common substrate (e.g., some of circuitry 62 may be mounted on printed circuit board 70 or some of circuitry 88 may be mounted on glass 54).

Touch sensor electrodes 48B may be formed from indium-tin oxide (ITO) or other suitable transparent conductive material. Touch sensor electrodes 48B may be formed in an array that includes numerous rows and columns of substantially rectangular electrode pads (as an example). At the edge of glass layer 50 (i.e., the left-hand edge of FIG. 5), some of the ITO traces on layer 50 may be used to form contact pads 48A. Contact pads 48A may be electrically interconnected (through ITO traces on layer 50) with the array of ITO electrodes. Traces in end 74 of flex circuit 72 may be electrically and physically connected to pads 48A using a heat-and-pressure-bondable conductive adhesive (as an example). End 76 of flex circuit 72 may be connected to circuitry 88 on printed circuit board 70 using zero-insertion-force (ZIF) connector 78 or other suitable flex circuit connection arrangement. Circuitry 88 may include circuitry for analyzing raw touch data from sensor array 48B. For example, circuitry 88 may include circuitry for measuring capacitance changes in the touch sensor electrodes and in determining the location of a user's finger or other external object on the array by processing the measured capacitance changes.

Printed circuit board 70 may be implemented using a rigid printed circuit board or a flexible printed circuit board. Rigid printed circuit boards may be formed from substrates such as fiberglass-filled epoxy. Flexible printed circuit boards (“flex circuits”) may be formed from sheets of polymers such as polyimide. The circuitry on printed circuit board 70 may include the main processing circuitry for device 10 (i.e., board 70 may be the main logic board for device 10) or, if desired, printed circuit board 70 may be a smaller board (e.g., a daughterboard) that is interconnected with a larger board.

Touch sensor electrodes 48B and glass 50 form the touch sensor structures of display module 20. Flex circuit 72 may be used to convey touch sensor signals from the touch sensor portion of module 20 to the circuitry on board 70 and may therefore serve as a touch sensor data path. Substrate 54, light-emitting diodes 52, and glass 50 form display structures for display module 20. Flex circuit 64 may be used to convey display data for the display portion of module 20 and may therefore serve as a display data path.

As shown in FIG. 5, end 74 of flex circuit 72 may be connected to the left-hand edge of display 20, whereas end 66 of flex circuit 64 may be connected to the right-hand edge of display 20. Because the touch sensor flex circuit and the display flex circuit are connected to the display module along different opposing edges of the display module, the contact pad areas for the flex circuits can be more evenly distributed than in arrangements in which the touch sensor and display flex circuits are attached to the display module on the same side. This allows the touch sensor contact region to be provided with sufficient area to form a satisfactory contact without overly enlarging any one edge of the display.

With the illustrative configuration of FIG. 5, touch sensor flex circuit 72 may, for at least some of its length, run vertically along the edge of housing 12, parallel to vertical dimension 84. Display flex circuit 64 may have a portion that runs vertically and a portion that runs horizontally, parallel to horizontal dimension 86. By running flex circuit 64 horizontally under display 20, it is possible for both flex circuits to be attached to printed circuit board 70 at the same end (i.e., the left-hand side of circuit board 70 in the example of FIG. 5).

This type of arrangement may facilitate assembly operations. For example, because end 76 of the touch flex and end 80 of the display flex are at the same edge of board 70 and are located along one of the edges of device housing 12, it is possible to tilt the display module into place in device 10, even after a technician has inserted the flex circuit ends into connectors 78 and 82. During this tilting operation, the flex circuits may pivot about the left-hand edge of printed circuit board 70 while the right-hand edge of the display module is inserted into housing 12 in direction 90. If the touch sensor and display flex circuits were attached to printed circuit board 70 at opposite ends of the board, it might be difficult or impossible to rotate the display into place once the flex circuits had been attached to the circuit board.

The configuration of FIG. 5 has a display data path flex that runs horizontally under the display, but this is merely illustrative. For example, if desired, display flex circuit 64 may be attached to printed circuit board 70 along the right-hand edge of board 70 and touch sensor flex circuit 72 may run horizontally under display 20 to connect to printed circuit board 70 along the same edge of board 70. Other arrangements are also possible (e.g., with touch and display data paths formed from cables other than flex circuits, with the data paths being terminated on the display structures and touch structures along different edges, etc.).

The foregoing is merely illustrative of the principles of this invention and various modifications can be made by those skilled in the art without departing from the scope and spirit of the invention.

What is claimed is:

1. A rectangular touch screen display module having four edges, comprising:
display structures;
touch sensor structures;
a display data path cable connected to the display structures at a first of the edges; and
a touch sensor cable connected to the touch sensor structures along a second of the edges.

2. The rectangular touch screen display module defined in claim 1 wherein the display data path cable comprises a flex circuit.

3. The rectangular touch screen display module defined in claim 2 wherein the touch sensor cable comprises a flex circuit.

4. The rectangular touch screen display module defined in claim 1 comprising:
a first dielectric layer;
a second dielectric layer;
display pixels interposed between the first dielectric layer and the second dielectric layer; and
touch sensor electrodes formed on the second dielectric layer, wherein the first and second dielectric layers and the display pixels are associated with the display structures and wherein the second dielectric layer and the touch sensor electrodes are associated with the touch sensor structures.

5. The rectangular touch screen display module defined in claim 4 wherein the display data path cable comprises a flex circuit connected to the first dielectric layer.

6. The rectangular touch screen display module defined in claim 5 wherein the touch sensor cable comprises a flex circuit connected to the second dielectric layer.

7. The rectangular touch screen display module defined in claim 6 wherein the first dielectric layer comprises a layer of glass having a ledge region in which the display data path cable is connected to the first dielectric layer.

8. An electronic device, comprising:
a substrate layer;
a light-emitting diode array on the substrate layer;
a glass layer that covers the light-emitting diode array, wherein the light-emitting diode array is interposed between the substrate layer and the glass layer;
an array of touch sensor electrodes on the glass layer;
a first flex circuit connected to the substrate layer that conveys image data to the light-emitting diode array;
a second flex circuit connected to the glass layer that receives touch sensor data from the array of touch sensor electrodes, wherein the substrate layer and the glass layer form part of a rectangular touch screen display having four edges and wherein the first flex circuit and the second flex circuit are each connected to a different one of the four edges.

9. The electronic device defined in claim 8 further comprising:
a housing; and
a cover glass, wherein the substrate layer, the light-emitting diode array, the glass layer, and the array of touch sensor electrodes are mounted in the housing and are covered by the cover glass.

10. The electronic device defined in claim 9 further comprising a printed circuit board in the housing, wherein the first flex circuit has first and second ends, wherein the second flex circuit has first and second ends, wherein the first end of the first flex circuit is connected to the substrate layer, wherein the second end of the first flex circuit is connected to the printed circuit board, wherein the first end of the second flex circuit is connected to the glass layer, wherein the second end of the second flex circuit is connected to the printed circuit board, wherein the printed circuit board has edges, and wherein the second ends of the first and second flex circuits are connected to the same edge of the printed circuit board.

11. The electronic device defined in claim 10 wherein the light-emitting diodes comprise organic light-emitting diodes and wherein the touch sensor electrodes comprise indium-tin oxide traces.

12. A touch screen display having four edges, comprising:
a first glass layer;
an array of light-emitting diodes on the first glass layer;
a second glass layer that is attached to the first glass layer and that covers the array of light-emitting diodes;
an array of touch sensor electrodes on the second glass layer;
a first cable connected to the first glass layer along a first of the edges, wherein the first cable conveys signals to the array of light-emitting diodes;
a second cable connected to the second glass layer along a second of the edges, wherein the second cable receives signals from the array of touch sensor electrodes.

13. The touch screen display defined in claim 12 wherein the first cable comprises a first flex circuit and wherein the second cable comprises a second flex circuit.

14. The touch screen display defined in claim 13 wherein the first flex circuit is attached to the first glass layer with a heat-and-pressure-bondable conductive adhesive.

15. The touch screen display defined in claim 14 wherein the first and second edges are opposing edges of the touch screen display and wherein the second flex circuit is attached to the second glass layer with a heat-and-pressure-bondable conductive adhesive.

16. The touch screen display defined in claim 13 wherein the first glass layer has a portion defining a ledge that is not covered by the second glass layer, the touch screen display further comprising display driver circuitry mounted on the ledge and wherein the first cable is connected to the first glass layer adjacent to the display driver circuitry on the ledge.

17. A touch screen display module having four edges, comprising:
a display;
a touch sensor;
a display data path flex circuit that is connected to the display at a first of the four edges; and
a touch sensor data path flex circuit that is connected to the touch sensor at a second of the four edges.

18. The touch screen display module defined in claim 17 wherein the first and second edges are opposite one another and wherein the display comprises an array of light-emitting diodes.

19. The touch screen display module defined in claim 18 wherein the touch sensor comprises an array of indium-tin oxide electrodes.

20. The touch screen display module defined in claim 19 further comprising a layer of glass on which the array of indium-tin oxide electrodes is formed, wherein the layer of glass encapsulates the array of light-emitting diodes.
